(19) United States
(12) Patent Application Publication
(10) Pub. No.: US 2023/0122300 A1
(43) Pub. Date: Apr. 20, 2023

(54) EYE-TRACKING WAVEGUIDES

(71) Applicant: Microsoft Technology Licensing, LLC, Redmond, WA (US)

(72) Inventors: Simo Kaarlo TAMMELA, Espoo (FI); Ari Juhani TERVONEN, Vantaa (FI); Mervi Kaarina YLA-JARKKO, Hameenlinna (FI); Klaus Henrik VALTTERI KALIMA, Porvoo (FI); Marco Ilmari MATTILA, Kauniainen (FI); Tomi Petteri PULLI, Helsinki (FI)

(73) Assignee: Microsoft Technology Licensing, LLC, Redmond, WA (US)

(21) Appl. No.: 17/450,963

(22) Filed: Oct. 14, 2021

(51) Int. Cl. G02B 27/00; G02B 27/01

(52) U.S. Cl. CPC G02B 27/0093; G02B 27/0172; G02B 2027/0178

(57) ABSTRACT

Examples are disclosed that relate to head-mounted display (HMD) devices and methods for detecting light reflected by a user's eye. In one example, an HMD device comprises a frame, a transparent cover substrate supported by the frame, and a display substrate supported by the frame. An eye-tracking light source is affixed to the frame. The eye-tracking light source is configured to emit eye-tracking light. At least one input optical element is configured to receive the eye-tracking light. A plurality of transparent delivery waveguides are integrated with the transparent cover substrate. Each of the transparent delivery waveguides comprises an output optical element configured to output the eye-tracking light towards a user's eye. In addition, each of the transparent delivery waveguides comprises a curved portion. The HMD device further comprises a camera configured to detect the eye-tracking light reflected by the user's eye.

### BACKGROUND

Some head-mounted display (HMD) devices include an eye-tracking system configured to track a user's eyes. For example, some augmented reality (AR) and virtual reality (VR) HMD devices perform eye tracking to determine a direction of the user's gaze. The direction of the user's gaze can be used to control the device, such as by moving a cursor, selecting an object based on the user's point of gaze, generating an expressive avatar, controlling a game, and providing remote eye-gaze visualization. In some examples, the eye-tracking system includes light sources located at a frame of an HMD device. Light emitted from the light sources reflects off the user's cornea and is detected by an eye-tracking camera. The detected light is then used to determine the direction of the user's gaze.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to head-mounted display (HMD) devices and methods for detecting light reflected by a user's eye. In one example, an HMD device comprises a frame, a transparent cover substrate supported by the frame, and a display substrate supported by the frame. An eye-tracking light source is affixed to the frame. The eye-tracking light source is configured to emit eye-tracking light. At least one input optical element is configured to receive the eye-tracking light emitted by the eye-tracking light source. A plurality of transparent delivery waveguides are integrated with the transparent cover substrate and configured to receive the eye-tracking light via the at least one input optical element. Each of the transparent delivery waveguides comprises an output optical element configured to output the eye-tracking light from the transparent delivery waveguide towards a user's eye. In addition, each of the transparent delivery waveguides comprises a curved portion between the at least one input optical element and the output optical element. The HMD device further comprises a camera configured to detect the eye-tracking light reflected by the user's eye.

In another example, a method for detecting light reflected by a user's eye is performed at an HMD device comprising a frame, a transparent cover substrate supported by the frame, a display substrate supported by the frame, and a plurality of transparent delivery waveguides integrated with the transparent cover substrate. The method comprises emitting eye-tracking light from an eye-tracking light source affixed to the frame of the HMD device. The eye-tracking light is provided to at least one input optical element for the plurality of transparent delivery waveguides. For each of the transparent delivery waveguides, the eye-tracking light is directed along a path that includes a curved portion between the at least one input optical element and an output optical element, and the eye-tracking light is output from the transparent delivery waveguide towards the user's eye via the output optical element. The method further comprises detecting, at a camera, the eye-tracking light reflected by the user's eye.

### BRIEF DESCRIPTION OF THE DRAWINGS

FIG. 1 shows one example of a head-mounted display (HMD) device.

FIG. 2 shows a schematic diagram of one example of an eye-tracking system that can be implemented with an HMD device.

FIG. 3A shows an HMD device according to examples of the present

disclosure.

FIG. 3B shows a right transparent cover substrate and an eye-tracking light source of the HMD device of FIG. 3A according to examples of the present disclosure.

FIG. 4 shows a schematic, top-down view of the right transparent cover substrate and eye-tracking light source of FIG. 3B according to examples of the present disclosure.

FIG. 5 shows a portion of another example of an HMD device comprising a transparent cover substrate and an eye-tracking light source according to examples of the present disclosure.

FIG. 6 shows a partial cross-sectional view of the transparent cover substrate of FIG. 5.

FIG. 7 shows another cross-section depicting a mirror embedded in the transparent cover substrate of FIG. 5.

FIG. 8 shows a portion of another example of an HMD device comprising a transparent cover substrate according to examples of the present disclosure.

FIG. 9 shows a portion of another example of an HMD device comprising a transparent cover substrate according to examples of the present disclosure.

FIG. 10 shows a flow diagram depicting an example method for detecting light reflected by a user's eye.

FIG. 11 shows a schematic diagram of an example computing system.

### DETAILED DESCRIPTION

As introduced above, some head-mounted display (HMD) devices include an eye-tracking system configured to track a user's eyes. For example, some augmented reality (AR) HMD devices perform eye tracking to determine a direction of the user's gaze. The direction of the user's gaze can be used to control the AR device, such as by moving a cursor, selecting an object based on the user's point of gaze, generating an expressive avatar, controlling a game, and providing remote eye-gaze visualization.

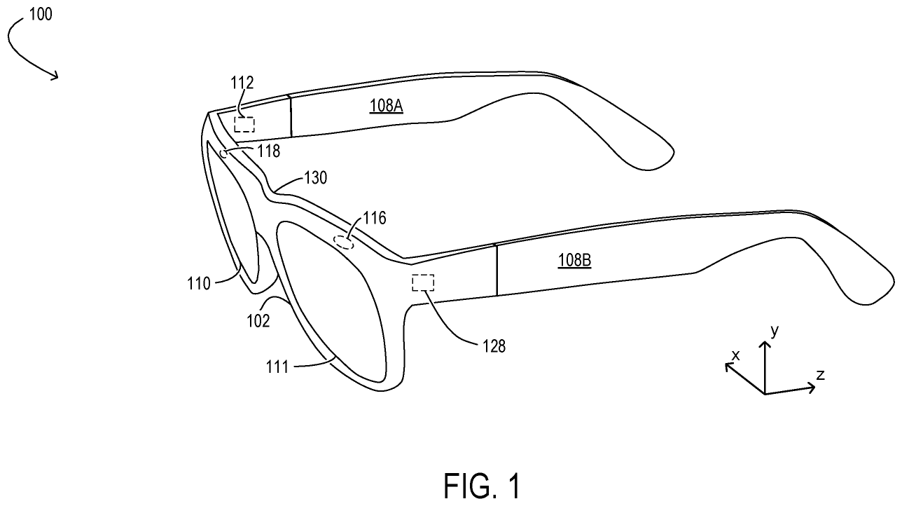

FIG. 1 shows one example of an HMD device 100. The HMD device 100 includes a frame 102, a display system, and temple pieces 108A, 108B. The display system includes a first display 110 and a second display 111 supported by the frame 102. Each of the first display 110 and the second display 111 include optical components configured to deliver a projected image to a respective eye of a user.

The display system of the HMD device 100 includes a first display module 112 for generating and displaying a first image via the first display 110 and a second display module 128 for generating and displaying a second image via the second display 111, where the first image and the second image combine to form a stereo image. In other examples, a single display module generates and displays first images and second images via the first display 110 and second display 111, respectively. Each display module may comprise any suitable display technology, such as a scanned beam projector, a microLED (light emitting diode) panel, a microOLED (organic light emitting diode) panel, or an LCoS (liquid crystal on silicon) panel, as examples. Further, various optics, such as waveguides, one or more lenses, prisms, and/or other optical elements may be used to deliver displayed images to a user's eyes.

The HMD device 100 further includes an eye-tracking system comprising a first eye-tracking camera 116 and a second eye-tracking camera 118. Data from the eye tracking system may be used to detect user inputs and to help render displayed images in various examples.

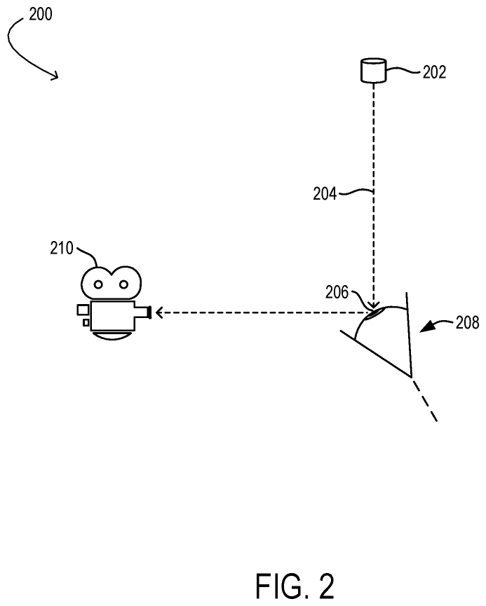

FIG. 2 shows a schematic diagram of one example of an eye-tracking system 200 that can be implemented at the HMD device 100 of FIG. 1. The eye-tracking system 200 includes a light source 202. Light 204 emitted by the light source 202 reflects off a cornea 206 of a user's eye 208 and is detected by a camera 210. A location of the corneal reflection relative to the user's eye indicates a direction of the user's gaze.

In some examples, the light source and the camera of the eye-tracking system are both located on a frame of an HMD device (e.g., on the frame 102 of FIG. 1). However, it can be challenging to arrange the light source and the camera such that the light can consistently and reliably reach the cornea, and the reflected light can consistently and reliably reach the camera. For example, a user's eyebrows may block the light emitted by the light source and/or received by the camera when the light source and/or the camera are close to the user's face. Further, light source(s) located at the frame of an HMD device may not illuminate the user's entire eye, thus providing poor angular exposure. These challenges are especially acute in small-form-factor HMD devices that are positioned near to the user's face and eyes when worn.

In some examples, small (e.g., 50 μm) light emitting diodes (LEDs) may be attached to the first display 110 and the second display 111. However, although the LEDs are small, the LEDs and their power leads may be visible to the user, which can be distracting and can obscure the user's vision through the displays and/or distort displayed images. Further, attaching LEDs to the display substrates can increase the complexity and cost of manufacturing the HMD.

In other examples, a planar waveguide may be incorporated into the displays or adjacent layers to linearly guide eye-tracking light to one or more desired output location(s). However, in these examples it can be challenging to place output optic(s) and the light source at desired locations, as planar waveguides are restricted to transporting light in straight lines which limits of the locations of the output optics and requires multiple separate light sources. These approaches can also introduce new challenges in the design of the display substrate and can disturb displayed images.

Accordingly, examples are disclosed that relate to HMD devices that include a plurality of transparent delivery waveguides that may utilize curved portions and are integrated with a transparent cover substrate. The plurality of transparent delivery waveguides are configured to receive eye-tracking light emitted by an eye-tracking light source via at least one input optical element. Each transparent delivery waveguide comprises an output optical element configured to output the eye-tracking light from the transparent delivery waveguide towards a user's eye. Advantageously and as described in more detail below, by utilizing transparent delivery waveguides that incorporate one or more curving portions, eye-tracking light can be delivered to and output from a plurality of desired locations in front of a user's eye, thereby providing more direct angles of incidence with the user's eye while also avoiding interference from eyebrows and/or other facial features. Accordingly, these transparent delivery waveguides enable HMD displays that are located close to a user's eyes, such as HMDs having form factors resembling traditional eyeglasses, to incorporate reliable and effective eye-tracking systems.

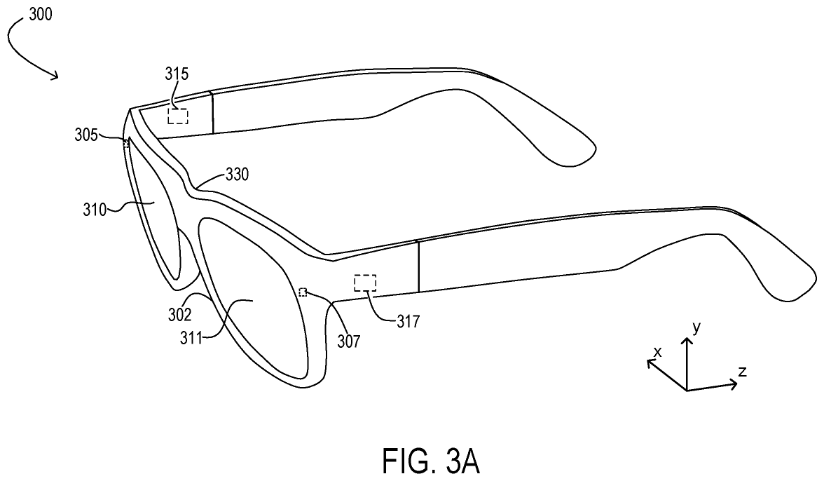

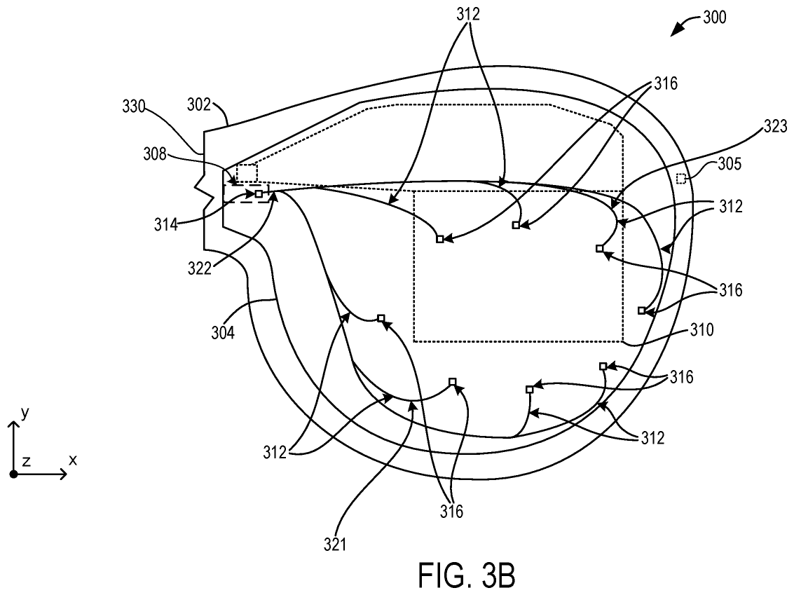

FIGS. 3A and 3B show an HMD device 300 according to one example of the present disclosure. In this example, the HMD device 300 comprises a frame 302 to which a right display substrate 310 and a left display substrate 311 are affixed. It will be appreciated that aspects of the present disclosure may be implemented in HMD devices having other form factors and designs, and in any other suitable device. For example, aspects of the present disclosure can be implemented in a head-mounted device that does not include a display, such as a pair of eyeglasses with a dedicated eye-tracking mechanism or other types of eyewear.

In this example, a right camera 305 and a left camera 307 are located at a right edge and a left edge of the frame 302, respectively, and are configured to detect eye-tracking light reflected by the user's right eye and left eye, respectively. In other examples, left and right cameras can be located at other locations on frame 302, such as at the nose bridge portion 330 of frame 302. In some examples as described below, the eye-tracking light comprises infrared light and the right camera 305 and left camera 307 comprise infrared cameras. At least a portion of the eye-tracking light is reflected by one of the user's eyes towards the right camera 305 or left camera 307, and these reflections are detected as bright spots on a surface of the user's eye. These spots are analyzed to determine a direction of the user's gaze.

A display system of the HMD device 300 includes a right display module 315 for generating and displaying a first image via the right display substrate 310 and a left display module 317 for generating and displaying a second image via the left display substrate 311, where the first image and the second image combine to form a stereo image. In other examples, a single display module generates and displays first images and second images via the right display substrate 310 and the left display substrate 311, respectively.

FIG. 3B shows a right portion of the HMD device 300 and frame 302 (as viewed from the user's right eye looking outwardly) that implements aspects of the present disclosure. The left portion of HMD device 300 and frame 302 may include the same components and configurations as the right portion described further below. In this example the right portion of HMD device 300 comprises a transparent cover substrate 304 that is supported by the frame 302. As described herein, a “transparent” component is one which allows light to pass through the component such that objects behind the component can be seen by a user. In some examples, the transparent cover substrate 304 comprises a protective polymer plate (e.g., polycarbonate or polyurethane). In the example of FIG. 3B, the transparent cover substrate 304 takes the form of a lens. For example, the transparent cover substrate may comprise a lens having a focal length in the range of 1-2 m. In other examples, the transparent cover substrate may have zero dioptric power (i.e., infinite focal length).

The right display substrate 310 is behind the transparent cover substrate 304 in this view and is coupled to the transparent cover substrate. In some examples, the HMD device 300 is an AR device and the right display substrate 310 is an at least partially transparent display. In other examples, an HMD device according to the present disclosure is a virtual reality (VR) device and right display substrate 310 is opaque to provide a more immersive viewing experience.

In the example of FIG. 3B, the transparent cover substrate 304 is supported directly by the frame 302. In some examples, the transparent cover substrate 304 is secured directly to the frame 302 (e.g., via an adhesive, a mechanical press fit, or a fastener). In other examples, the transparent cover substrate 304 is supported by the frame 302 indirectly via another component of the HMD 300, such as the right display substrate 310. It will also be appreciated that the right display substrate 310 may be coupled to the transparent cover substrate 304 directly or indirectly, and that there may be a space between the transparent cover substrate 304 and the right display substrate 310.

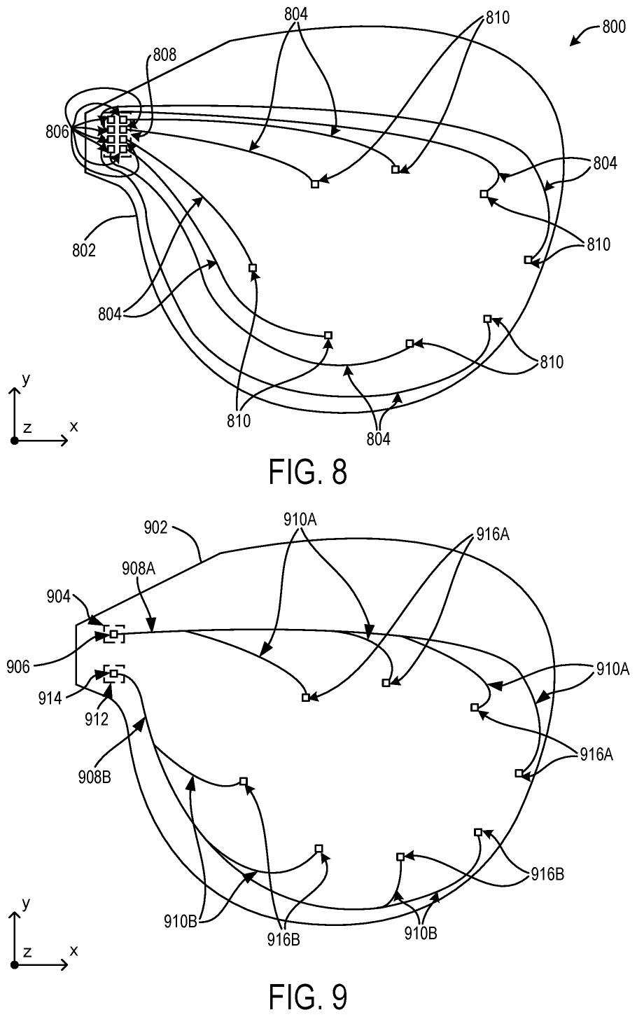

The HMD device 300 further comprises an eye-tracking light source 308 that is affixed to the frame 302. In some examples, the eye-tracking light source 308 is directly affixed to the frame. For example, the eye-tracking light source may be at least partially embedded inside the bridge portion 330 or mounted on an exterior surface or edge of the frame 302. It will also be appreciated that the eye-tracking light source 308 may be located at any other suitable location on HMD device 300. For example, the eye-tracking light source may be integrated into the transparent cover substrate 304. In yet other examples, and as described in more detail below with reference to FIG. 8, an HMD device may include a plurality of light sources.

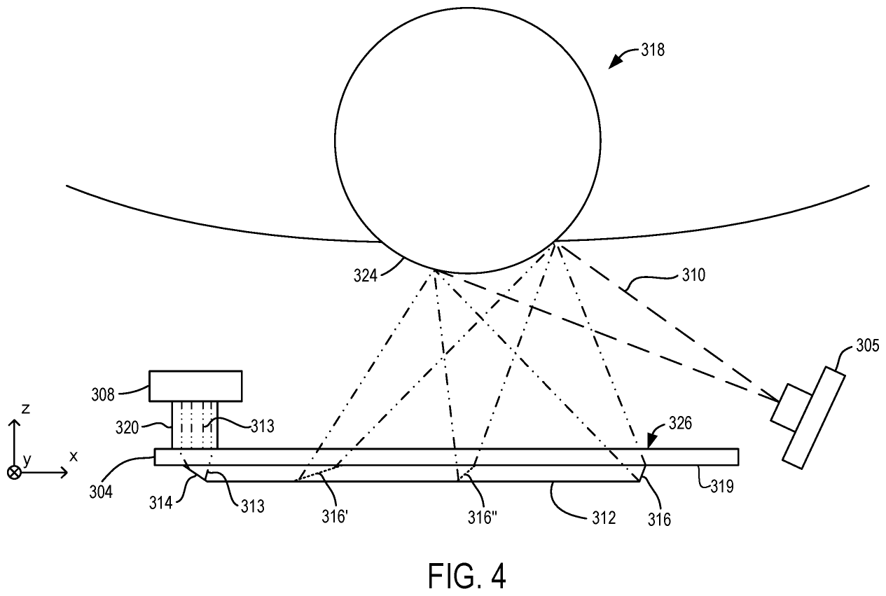

FIG. 4 shows a schematic top-down view of the transparent cover substrate 304 and the eye-tracking light source 308 of FIG. 3B. In this view the frame 302 and left display substrate 311 are omitted for clarity. As shown in FIG. 4, the eye-tracking light source 308 is configured to emit eye-tracking light 313. In some examples, the eye-tracking light source 308 comprises a vertical cavity surface emitting laser (VCSEL). In other examples, the eye-tracking light source 308 may comprise any other suitable type of light source, such as another type of laser, an LED or a superluminescent diode (SLED).

In some examples, the eye-tracking light 313 comprises infrared light having a wavelength in the range of 700 nm-2 μm. For example, the eye-tracking light 313 may comprise infrared light having a wavelength of 850 nm. It will also be appreciated that the eye-tracking light 313 may have any other suitable wavelength.

In the example of FIG. 4, the eye-tracking light source 308 is optically coupled to a lens 320 that is configured to direct the eye-tracking light 313 onto one or more input optical elements 314. The lens 320 may comprise any suitable type of lens. For example, the lens 320 may be configured to collimate or focus the eye-tracking light 313 output by the eye-tracking light source 308 onto the one or more input optical elements 314.

The input optical element 314 is configured to receive the eye-tracking light emitted by the eye-tracking light source 308. In some examples, the input optical element comprises a mirror, such as a silvered mirror, a dielectric mirror, or a Bragg mirror.

In yet other examples, the input optical element comprises a diffractive grating, such as a surface relief grating (SRG). The SRG comprises periodic surface variations formed in the surface of an optical element, such as the transparent delivery waveguide 312. The SRG may include uniform straight grooves in a surface of an optical component that are separated by uniform straight groove spacing regions. The nature of diffraction caused by an SRG depends on the wavelength, polarization and angle of light incident on the SRG and various optical characteristics of the SRG, such as refractive index, line spacing, groove depth, groove profile, groove fill ratio and groove slant angle. An input SRG on a surface of the transparent delivery waveguide 312 can be used to input light into the waveguide. In some examples, an SRG can be implemented by replacing a low-refractive-index material surrounding the transparent delivery waveguide 312 with a scattering, high-refractive-index material.

As described in more detail below, the transparent delivery waveguide 312 is configured to direct the eye-tracking light 313 along a path that includes one or more curved portions to an output optical element 316 configured to output the eye-tracking light towards a user's eye 318.

With reference again to FIG. 3B, the HMD 300 further comprises a plurality of transparent delivery waveguides 312. As described in more detail below, the plurality of transparent delivery waveguides 312 are integrated with the transparent cover substrate and are configured to receive the eye-tracking light 313 via at least one input optical element 314. Additionally, as described in more detail below and in one potential advantage of the present disclosure, each of the transparent delivery waveguides 312 comprises a curved portion between an input optical element and a corresponding output optical element.

Each transparent delivery waveguide 312 is an optical component configured to transport the eye-tracking light 313 by way of internal reflection (e.g., total internal reflection) within the waveguide. As described in more detail below, each waveguide may be used to transport the eye-tracking light 313 from the light source 308 to one or more locations on the transparent cover substrate 304, where it is output towards a user's eye.

In the example of FIGS. 3B and 4, each of the waveguides 312 traverses a path substantially parallel to the XY plane. In this example the thickness of the waveguide 312 is a Z-axis dimension of the waveguide, and the width of the waveguide is a dimension that is perpendicular to a direction of travel of the waveguide and the thickness of the waveguide. For example, where a waveguide travels parallel to the X-axis, the width of the waveguide is a Y-axis dimension of the waveguide.

In the example of FIG. 3B, each of the transparent waveguides 312 (and the eye-tracking light guided by the waveguides) generally travels in the positive X-axis direction away from the light source 308 and across the transparent cover substrate 304. Advantageously and as described in more detail below, each of the transparent waveguides 312 comprises a curved portion between the input optical element 314 and an output optical element 316. In this example, each of the transparent waveguides 312 is curved such that at least a portion of each transparent waveguide also has a displacement in the Y-axis direction. In this manner, and in one potential advantage of the present disclosure, eye-tracking light can be delivered to and output from a wide variety of desired locations in front of a user's eye, where such locations can be more difficult or impossible to reach using waveguides that travel in straight lines.

In some examples, at least one of the transparent delivery waveguides 312 comprises a transparent polymer material. Some examples of suitable materials include a silicone polymer, a thermosetting polymer, an ultraviolet (UV)-cured polymer, and an optical resin. It will also be appreciated that any other suitable material may be used. For example, the waveguide may comprise an optical fiber, silica, or similar materials. Advantageously, by forming the transparent delivery waveguides 312 from a transparent polymer material, the waveguides may be unobtrusive and essentially invisible to the user. Further, with this configuration the transparent delivery waveguides 312 can be positioned in front of the user's eyes and deliver light to locations directly within the user's field of view without obscuring and/or distorting the user's vision.

Further, each of the transparent delivery waveguides may have a thickness and/or a width of less than 1 mm. In some examples, the waveguide has a thickness and a width of approximately 50 μm. The small thickness and/or width of the waveguide may further contribute to making the waveguide inconspicuous. Further, the compact dimensions of the transparent delivery waveguide enable it to be connected to small optical structures or integrated with additional waveguides and/or other components to form a larger structure.

In some examples, the material of the transparent delivery waveguides 312 has an adjustable refractive index. In some examples, the refractive index of the material is tunable to an index value in the range of 1.4-1.9. In this manner and in these examples, the transparent delivery waveguide structure can be formed in a polymer sheet. For example, one or more layers of a polymer can be spin-coated, dip-coated, or roll-to-roll wet coated on a substrate to form the waveguide. In some examples, the waveguide structure is formed on a substrate comprising a plate or film (e.g., a polymer film, such as a thermoplastic). It will also be appreciated that the waveguide can be formed using any other suitable manufacturing process. For example, the waveguide can be formed using lithography, printing, UV-imprinting, or hot-imprinting.

In some examples, one or more of the transparent delivery waveguides 312 may be formed directly on the transparent cover substrate 304. In other examples, one or more of the transparent delivery waveguides 312 are formed in a separate process, then applied to the transparent cover substrate 304. For example, and as described in more detail below with reference to FIGS. 4-6, the transparent delivery waveguides 312 can be laminated onto the transparent cover substrate 304, embedded in the transparent cover substrate 304, or applied onto the transparent cover substrate 304 using a transparent adhesive and/or one or more mechanical fasteners. In some examples, applying pre-formed waveguides to the transparent cover substrate may be easier, faster, and cheaper than forming the transparent delivery waveguides directly on the transparent cover substrate.

It will also be appreciated that one or more of the transparent delivery waveguides 312 may comprise any other suitable materials or construction having any other suitable dimensions. For example, in some examples a transparent delivery waveguide can be formed by embedding optical fiber (e.g., fiber optic glass) into the transparent cover substrate 304. As another example, a transparent delivery waveguide can be formed by etching the transparent cover substrate 304.

As noted above, each transparent delivery waveguide 312 comprises an output optical element 316 configured to output the eye-tracking light 313 from the transparent delivery waveguide towards a user's eye. The output optical elements 316 are provided at various locations relative to the transparent cover substrate 304. Advantageously and as noted above, the transparent delivery waveguides 312 may be curved, shaped, and otherwise directed in non-linear paths to deliver the eye-tracking light 313 to each of the output optical elements 316 at a wide variety of locations that would be more challenging or impossible to reach using linear planar waveguides. In this manner, the present configurations provide greater flexibility in the placement of the output optical elements 316 and more direct angles of incidence with the user's eye, thereby improving the reliability and effectiveness of the eye-tracking system.

In the example of FIG. 3B, each transparent delivery waveguide 312 comprises a curved portion between the input optical element 314 and a corresponding output optical element 316. Examples of curved portions 321 and 323 are indicated in FIG. 3B. A transparent delivery waveguide 312 may be curved in two or three dimensions. In this manner, the waveguide can be arranged to fit within the dimensions of a device and curved to direct the light along a desired path to one or more output locations and/or to conform to a contour of the transparent cover substrate 304. Further and with some transparent delivery waveguides 312, directing the waveguide in a curved path may reduce the perceptibility of the waveguide to the user (e.g., by directing the waveguide around a display area where the user's gaze will be most often focused).

In some examples and as shown in FIG. 3B, the input optical element 314 is optically coupled to a transparent feeder waveguide 322. The transparent feeder waveguide 322 is configured to receive the eye-tracking light from the input optical element 314. The transparent feeder waveguide 322 then branches into the plurality of transparent delivery waveguides 312. In the example of FIG. 3B, the transparent feeder waveguide 322 branches into eight transparent delivery waveguides 312. In this manner, the transparent feeder waveguide 322 allows the eye-tracking light received from one light source to be delivered to a plurality of output locations by branching the transparent delivery waveguides 312. In another potential advantage of the present disclosure, this configuration helps to avoid issues with beam alignment that can arise in designs based on planar waveguides, where the light travels without full confinement.

Each of the eight transparent delivery waveguides 312 of FIG. 3B comprises an output optical element 316 configured to output the eye-tracking light from the transparent delivery waveguide 312 towards a user's eye. In some examples, the output optical element 316 comprises a mirror (e.g., a silvered mirror, a dielectric mirror, or a Bragg mirror). In other examples, the output optical element comprises a prism. In yet other examples, the output optical element comprises a diffractive grating, such as an SRG.

Turning now to FIG. 4, a plurality of output optical elements 316, 316′, and 316″ are schematically illustrated. In the example of FIG. 4, the output optical element 316 is located at a distal end of the illustrated transparent delivery waveguide 312. The other output optical elements 316′ and 316″ are associated with other transparent delivery waveguides that are located above or below transparent delivery waveguide 312, with such other transparent delivery waveguides not shown in FIG. 4 for clarity.

Each output optical element 316 is configured to direct the eye-tracking light 313 towards the cornea 324 of the user's eye 318. In some examples, the output optical element 316 may comprise an angled mirror. Each of the output optical elements 316 is located at a different position on the transparent cover substrate 304. Based on this position, each of the output optical elements 316 is oriented and/or angled to direct the eye-tracking light 313 towards the cornea 324 of the user's eye 318.

The location of each of the output optical elements 316 is selected so that eye-tracking light 313 output by at least a portion of the output optical elements 316 reaches and is reflected by the cornea of a user's eye towards the eye-tracking camera 305, regardless of the position of the user's eye or the direction of the user's gaze. In different examples, the location of each of the output optical elements 316 may be dictated by the shape of the transparent cover substrate 304, the location of the eye-tracking camera 305, and/or the location of a prospective user's eye relative to the HMD device 300. In some examples, each of the output optical elements 316 is located approximately 17 mm from the user's eye. In other examples, one or more of the output optical elements 316 may be provided at any other suitable location.

The number of transparent delivery waveguides 312 and corresponding output optical elements 316 in a given HMD device is also related to the shape of the transparent cover substrate, the location of the eye-tracking camera, and the expected location of the user's eye with respect to these components. In the example of FIG. 3B, eight transparent delivery waveguides 312 and eight corresponding output optical elements 316 are located at the transparent cover substrate 304. In other examples, any other suitable number of transparent delivery waveguides 312 and output optical elements 316 may be used. For example, three or four transparent delivery waveguides 312 and output optical elements 316 may be used to illuminate the user's eye from a suitable range of angles for eye-tracking. In other examples, it may be useful to include more transparent delivery waveguides 312 and output optical elements 316 to provide sufficient coverage of emitted eye-tracking light for different users who have different interpupillary distances and other anatomical differences.

In some examples, at least one of the transparent delivery waveguides 312 is affixed to an exterior surface of the transparent cover substrate 304. In the example of FIG. 4, the transparent delivery waveguide 312 is located on the outwardly facing exterior surface 319 of the transparent cover substrate 304, opposite the light source 308 and user's eye 318. In other examples, the transparent delivery waveguide 312 may be affixed to a user-facing exterior surface of the transparent cover substrate 304 that is facing the user's eye. With reference also to FIG. 3B, in this example the transparent delivery waveguide 312 is located between the transparent cover substrate 304 and the right display substrate 310. In other examples, the transparent cover substrate 304 is positioned between the transparent delivery waveguide 312 and the right display substrate 310, or arranged in any other suitable manner. It will also be appreciated that the light source 308 may be arranged in any other suitable manner with respect to the transparent cover substrate 304. For example, the light source 308 may be located on the outwardly facing exterior surface 319 of the transparent cover substrate 304, opposite the user's eye 318.

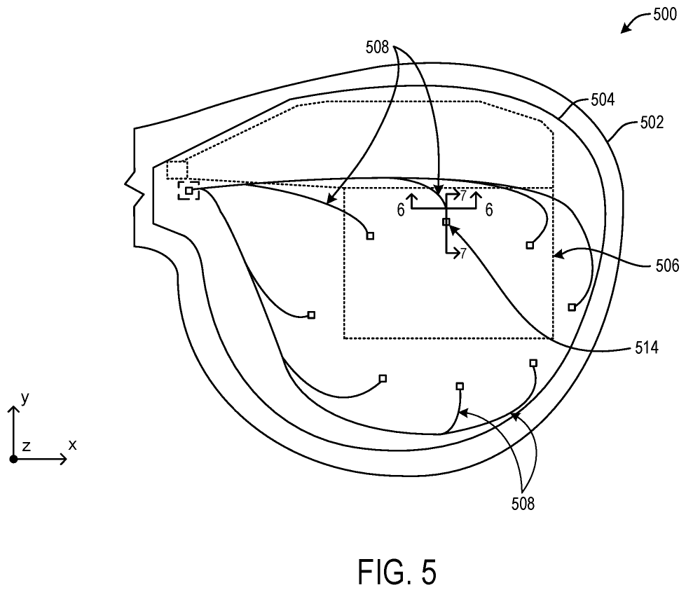

FIG. 5 shows a portion of another example of an HMD device 500 that can implement aspects of the present disclosure. Like the HMD device 300 of FIGS. 3A, 3B, and 4, the HMD device 500 comprises a frame 502, a transparent cover substrate 504 supported by the frame 502, and a display substrate 506 supported by the frame 502. A plurality of transparent delivery waveguides 508 are integrated with the transparent cover substrate 504. FIG. 5 shows a right portion of the HMD device 500 and frame 502 (as viewed from the user's right eye looking outwardly) that implements aspects of the present disclosure. The left portion of HMD device 500 and frame 502 may include the same components and configurations as the right portion described further below. Additionally, and as described further below, while the HMD device 300 of FIGS. 3A, 3B, and 4 includes transparent delivery waveguides 312 affixed to an exterior surface 319 of the transparent cover substrate 304, HMD device 500 utilizes transparent delivery waveguides 508 that are embedded in the transparent cover substrate 504.

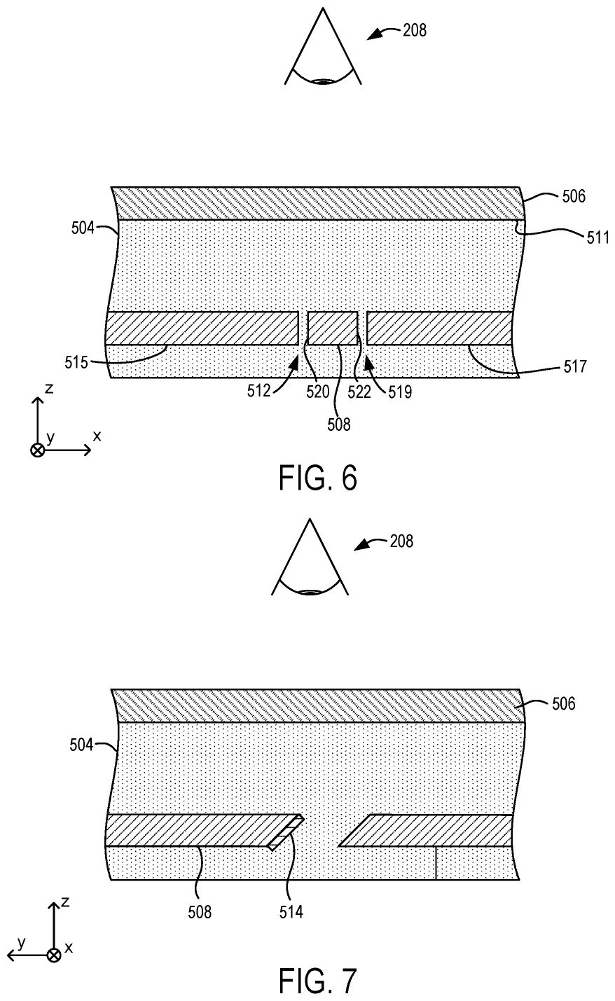

FIG. 6 shows a partial cross-sectional view (not to scale) of a portion of the transparent cover substrate 504 along line 6-6 shown in FIG. 5 that includes a cross section of one transparent delivery waveguide 508 taken above its corresponding output optical element 514. As shown in FIG. 6, the delivery waveguide 508 is embedded in the transparent cover substrate 504. In this example, embedding the transparent delivery waveguide 508 in the transparent cover substrate 504 may help to protect the waveguide and reduce contrast between the waveguide and the transparent cover substrate, thereby making it less visible to a user.

As introduced above, the transparent delivery waveguide 508 can be formed in a separate process and then embedded in the transparent cover substrate 504. In other examples, the transparent delivery waveguide 508 can be formed in between layers of the transparent cover substrate 504, for example by lamination or integration by in-mold labeling/decoration injection molding.

In the example shown in FIG. 6, the display substrate 506 is affixed or bonded to an exterior top surface 511 of the transparent cover substrate 504 above the transparent delivery waveguide 508 (with respect to the Z-axis), such that the display substrate 506 is located between the transparent cover substrate 504 and a user's eye 208. In other examples, the transparent delivery waveguides 508 and the display substrate 506 may be arranged in any other suitable manner. For example, the transparent delivery waveguide 508 may be arranged above the display substrate 506 between the user's eye 208 and the display substrate 506. As another example, the display substrate 506 may be embedded within the transparent cover substrate 504. In other examples, there may be a space between the display substrate 506 and the transparent cover substrate 504.

In this example, the transparent delivery waveguide 508 is adjacent to a first layer 515 and an opposing second layer 517, where both the first layer 515 and the second layer 517 are formed of the same material as the transparent delivery waveguide. In other examples, each layer may comprise a different material having the same refractive index as the transparent delivery waveguide 508. In the example of FIG. 6, each of the first and second layers 515, 517 has the same thickness (in the z-axis direction) as the transparent delivery waveguide 508. In other examples, the layers 515, 517 may have a different thickness than the thickness of the transparent delivery waveguide 508. As described in more detail below, each of the first layer 515 and the second layer 517 is separated from the waveguide 508 by a first space 512 and a second space 519, respectively, which together define the structure of the waveguide 508.

Each of the first layer 515 and the second layer 517 extends across an area of the transparent cover substrate 504. In the example of FIGS. 5-7, the first and second layers 515, 517 are coplanar with the waveguide 508, and the area of the transparent cover substrate 504 that the layers 515, 517 extend across is parallel to the XY-plane. In some examples, the first and second layers 515, 517 may each extend from the waveguide 508 to the edges of the frame 502. In other examples, the first and second layers 515, 517 may extend from the waveguide 508 to the location of another waveguide. In the example of FIGS. 5-7, the first and second layers 515, 517 are embedded in the transparent cover substrate 504; thus, the layers extend across an area that is inside of the transparent cover substrate 504. In other examples, the layer may extend across an external area of the transparent cover substrate.

As introduced above, the transparent delivery waveguide 508 is defined by a first space 512 and second space 519 separating the transparent delivery waveguide 508 from the first and second layers 515, 517. For example, the waveguide 508 may be formed by applying a single layer of material (e.g., a thin polymer film) to the substrate 504 and removing (e.g., by cutting away) portions of the material to form the first and second spaces 512 and 519, which define the structures of waveguide 508 and the first and second layers 515, 517 adjacent to the waveguide. For example, a first space 512 separates a first side wall 520 of the waveguide 508 from a first layer 515 and a second space 519 separates a second side wall 522 of the waveguide 508 from a second layer 517. The first and second spaces 512, 519 may be occupied by a material having a lower refractive index than the waveguide 508, such as the material forming the transparent cover substrate 504, or air.

With reference now to FIG. 7, a partial cross-sectional view (not to scale) of the transparent cover substrate 504 along line 7-7 of FIG. 5 is shown. In this view, an output optical element 514 in the form of a mirror is embedded inside the transparent cover substrate 504 at the terminal end of one of the transparent delivery waveguides 508. In this example, embedding the mirror can help protect the mirror and help to reduce its visibility relative to an exposed mirror. In other examples, the waveguide 508 may be located above the display substrate 506 and the angle of the output optical element 514 is adjusted to direct the eye-tracking light towards the cornea of the user's eye 318.

FIG. 8 shows a portion of another example of an HMD device 800 that can implement aspects of the present disclosure. Like the HMD devices described above, the HMD device 800 comprises a frame 802, a transparent cover substrate 804 supported by the frame 802, and a display substrate (not shown for clarity) supported by the frame 802. FIG. 8 shows a right portion of the HMD device 800 and frame 802 (as viewed from the user's right eye looking outwardly) that implements aspects of the present disclosure. The left portion of HMD device 800 and frame 802 may include the same components and configurations as the right portion described further below.

In the example of FIG. 8, each transparent delivery waveguide 804 comprises or is coupled to a separate input optical element 806. A plurality of output optical elements 810 are configured to receive eye-tracking light via the plurality of transparent delivery waveguides 804. Like the example embodiment of FIG. 3B, each output optical element 810 is associated with an individual transparent delivery waveguide 804.

In the example of FIG. 8, and in one potential advantage of this example, the plurality of input optical elements 806 are located close to one another, such that all the input optical elements are configured to receive eye-tracking light emitted by a single eye-tracking light source 808. In other examples, one or more of the input optical elements 806 can be provided at different locations on the transparent cover substrate 802, thereby enabling the use of multiple light sources.

FIG. 9 shows another example embodiment of a transparent cover substrate 902 and a plurality of transparent delivery waveguides 910 that may be utilized in HMD devices according to examples of the present disclosure. Other components of the HMD device, such as the frame and the display substrate, are not shown in FIG. 9 for clarity. FIG. 9 shows a right portion of the HMD device and frame 902 (as viewed from the user's right eye looking outwardly) that implements aspects of the present disclosure. The left portion of HMD device and frame 902 may include the same components and configurations as the right portion described further below

In this example, the HMD device comprises a first eye-tracking light source 904 and a first input optical element 906 configured to receive eye-tracking light emitted by the first eye-tracking light source 904. A first transparent feeder waveguide 908A is configured to receive the eye-tracking light emitted by the first eye-tracking light source 904 from the first input optical element 906. The first transparent feeder waveguide 908A then branches into a plurality of first transparent delivery waveguides 910A integrated with the transparent cover substrate 902. In the example of FIG. 9, the first transparent feeder waveguide 908A branches into four first transparent delivery waveguides 910A. Like the transparent delivery waveguides 312 of FIGS. 3A, 3B, and 4, each of the first transparent delivery waveguides 910A comprises a curved portion between the first input optical element 906 and a corresponding first output optical element 916A.

In this example, the HMD device comprises a second eye-tracking light source 912 and a second input optical element 914 configured to receive eye-tracking light emitted by the second eye-tracking light source. A second transparent feeder waveguide 908B is configured to receive the eye-tracking light emitted by the second eye-tracking light source 912 from the second input optical element 914. The second transparent feeder waveguide 908B then branches into a plurality of second transparent delivery waveguides 910B. The plurality of second transparent delivery waveguides 910B are configured to receive the eye-tracking light emitted by the second eye-tracking light source 912 via the second input optical element 914 and the second transparent feeder waveguide 908B.

Each of the second transparent delivery waveguides 910B comprises a corresponding second output optical element 916B configured to output, from the associated second transparent delivery waveguide 910B, the eye-tracking light emitted by the second eye-tracking light source 912 towards a user's eye. As in the embodiments shown in FIGS. 3A, 3B and 8, each of the second transparent delivery waveguides 910B comprises a curved portion between the second transparent feeder waveguide 908B and the second output optical element 916B. In this manner, the HMD device may accommodate a plurality of light sources and output locations. Advantageously, the use of two or more light sources and two or more sets of output locations can be used to accommodate a range of user interpupillary distances within the same device. For example, to accommodate users with a relatively short interpupillary distance, the output locations may be arranged closer to a bridge portion of the HMD device than for users with a relatively longer pupillary distance.

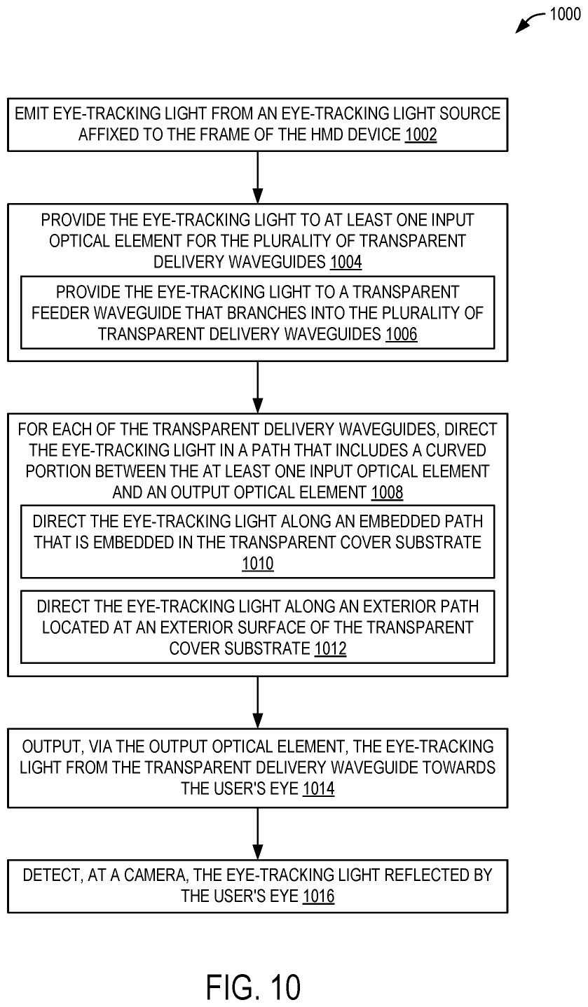

FIG. 10 illustrates a flowchart depicting an example method 1000 for detecting light reflected by a user's eye. In some examples, the method 1000 is performed at an HMD device comprising a frame, a transparent cover substrate supported by the frame, a display substrate supported by the frame, and a plurality of transparent delivery waveguides integrated with the transparent cover substrate. The following description of method 1000 is provided with reference to the software and hardware components described above and shown in FIGS. 1-9 and 11, and also can be used with any other suitable eye-tracking device, including devices that do not include a display. It will be appreciated that the following description of method 1000 is provided by way of example and is not meant to be limiting. Various steps of method 1000 can be omitted or performed in a different order than described, and method 1000 can include additional and/or alternative steps relative to those illustrated in FIG. 10 without departing from the scope of this disclosure.

At 1002, the method 1000 includes emitting eye-tracking light from an eye-tracking light source affixed to the frame of the HMD device. At 1004, the method 1000 includes providing the eye-tracking light to at least one input optical element for the plurality of transparent delivery waveguides. For example, and as described above with reference to FIG. 4, the eye-tracking light 313 is emitted from the eye-tracking light source 308. The eye-tracking light 313 is then provided to the input optical element 314 for the plurality of transparent delivery waveguides 312. The method 1000 may further include providing the eye-tracking light to a transparent feeder waveguide that branches into the plurality of transparent delivery waveguides. For example, the eye-tracking light may be provided to the transparent feeder waveguide 322 of FIG. 3B via the input optical element 314. The transparent feeder waveguide 322 then branches into the plurality of transparent delivery waveguides 312.

For each of the transparent delivery waveguides, the method 1000 includes, at 1008 directing the eye-tracking light along a path that includes a curved portion between the at least one input optical element and an output optical element. The method 1000 may include, at 1010, directing the eye-tracking light along an embedded path that is embedded in the transparent cover substrate. For example, the eye-tracking light may be directed along a waveguide 508 that is embedded in the transparent cover substrate 504 of FIG. 5. In other examples, the method 1000 may include, at 1012, directing the eye-tracking light along an exterior path located at an exterior surface of the transparent cover substrate. For example, the eye-tracking light may be directed along the waveguide 312 of FIG. 4 that is affixed or bonded to an exterior surface of the transparent cover substrate 304.

Next, at 1014, the method 1000 includes outputting, via the output optical element, the eye-tracking light from the transparent delivery waveguide towards the user's eye. The method 1000 further includes, at 1016, detecting, at a camera, the eye-tracking light reflected by the user's eye. The eye-tracking light reflected by the user's eye can then be used to determine a direction of the user's gaze.

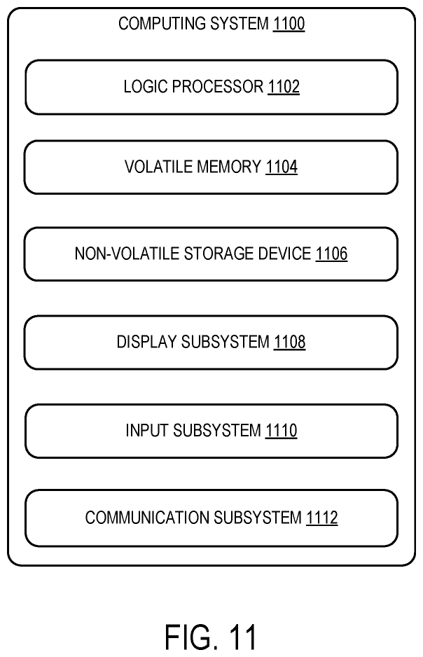

FIG. 11 schematically shows an example of a computing system 1100 that can be utilized in one or more of the devices and methods described above. Computing system 1100 is shown in simplified form. Computing system 1100 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head-mounted augmented reality devices. In some examples, the HMD device 100 may include the computing system 1100 or one or more components of the computing system. The computing system 1100 includes a logic processor 1102, volatile memory 1104, and a non-volatile storage device 1106. The computing system 1100 may optionally include a display subsystem 1108, input subsystem 1110, communication subsystem 1112, and/or other components not shown in FIG. 11.

Logic processor 1102 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1102 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1106 includes one or more physical devices configured to hold instructions executable by the logic processors to implement the methods and processes described herein. When such methods and processes are implemented, the state of non-volatile storage device 1106 may be transformed—e.g., to hold different data.

Non-volatile storage device 1106 may include physical devices that are removable and/or built-in. Non-volatile storage device 1106 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1106 may include nonvolatile, dynamic, static, read/write, read-only, sequential-access, location-addressable, file-addressable, and/or content-addressable devices. It will be appreciated that non-volatile storage device 1106 is configured to hold instructions even when power is cut to the non-volatile storage device 1106.

Volatile memory 1104 may include physical devices that include random access memory. Volatile memory 1104 is typically utilized by logic processor 1102 to temporarily store information during processing of software instructions. It will be appreciated that volatile memory 1104 typically does not continue to store instructions when power is cut to the volatile memory 1104.

Aspects of logic processor 1102, volatile memory 1104, and non-volatile storage device 1106 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 1100 typically implemented in software by a processor to perform a particular function using portions of volatile memory, which function involves transformative processing that specially configures the processor to perform the function. Thus, a program may be instantiated via logic processor 1102 executing instructions held by non-volatile storage device 1106, using portions of volatile memory 1104. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

When included, display subsystem 1108 may be used to present a visual representation of data held by non-volatile storage device 1106. As the herein described methods and processes change the data held by the non-volatile storage device, and thus transform the state of the non-volatile storage device, the state of display subsystem 1108 may likewise be transformed to visually represent changes in the underlying data. Display subsystem 1108 may include one or more display devices utilizing virtually any type of technology. Such display devices may be combined with logic processor 1102, volatile memory 1104, and/or non-volatile storage device 1106 in a shared enclosure, or such display devices may be peripheral display devices.

When included, input subsystem 1110 may comprise or interface with one or more user-input devices such as a keyboard, mouse, touch screen, or game controller. In some examples, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1112 may be configured to communicatively couple various computing devices described herein with each other, and with other devices. Communication subsystem 1112 may include wired and/or wireless communication devices compatible with one or more different communication protocols. For example, the communication subsystem may be configured for communication via a wireless telephone network, or a wired or wireless local- or wide-area network. In some examples, the communication subsystem may allow computing system 1100 to send and/or receive messages to and/or from other devices via a network such as the Internet.

The following paragraphs provide additional support for the claims of the subject application. One aspect provides an HMD device comprising: a frame; a transparent cover substrate supported by the frame; a display substrate supported by the frame; an eye-tracking light source affixed to the frame, the eye-tracking light source configured to emit eye-tracking light; at least one input optical element configured to receive the eye-tracking light emitted by the eye-tracking light source; a plurality of transparent delivery waveguides integrated with the transparent cover substrate and configured to receive the eye-tracking light via the at least one input optical element, each of the transparent delivery waveguides comprising an output optical element configured to output the eye-tracking light from the transparent delivery waveguide towards a user's eye, wherein each of the transparent delivery waveguides comprises a curved portion between the at least one input optical element and the output optical element; and a camera configured to detect the eye-tracking light reflected by the user's eye.

The at least one transparent delivery waveguide of the plurality of transparent delivery waveguides may additionally or alternatively include a polymer material. At least one transparent delivery waveguide of the plurality of transparent delivery waveguides may be additionally or alternatively embedded in the transparent cover substrate. At least one transparent delivery waveguide of the plurality of transparent delivery waveguides may be additionally or alternatively affixed to an exterior surface of the transparent cover substrate. The HMD device may additionally or alternatively include a transparent feeder waveguide configured to receive the eye-tracking light from the at least one input optical element, wherein the transparent feeder waveguide branches into the plurality of transparent delivery waveguides. Each transparent delivery waveguide of the plurality of transparent delivery waveguides may additionally or alternatively include an input optical element.

The eye-tracking light source may additionally or alternatively comprise a first eye-tracking light source, the at least one input optical element may additionally or alternatively comprise a first input optical element, the plurality of transparent delivery waveguides may additionally or alternatively comprise a plurality of first transparent delivery waveguides, the output optical element may additionally or alternatively comprise a first output optical element, and each of the first transparent delivery waveguides may additionally or alternatively comprise a first curved portion between the first input optical element and the first output optical element, and the HMD device may additionally or alternatively include: a first transparent feeder waveguide configured to receive the eye-tracking light emitted by the first eye-tracking light source from the first input optical element, wherein the first transparent feeder waveguide branches into the plurality of first transparent delivery waveguides; a second eye-tracking light source affixed to the frame; a second input optical element configured to receive eye-tracking light emitted by the second eye-tracking light source; and a second transparent feeder waveguide configured to receive the eye-tracking light emitted by the second eye-tracking light source from the second input optical element, wherein the second transparent feeder waveguide branches into a plurality of second transparent delivery waveguides integrated with the transparent cover substrate and configured to receive the eye-tracking light emitted by the second eye-tracking light source via the second input optical element and the second transparent feeder waveguide, each of the second transparent delivery waveguides comprising a second output optical element configured to output the eye-tracking light emitted by the second eye-tracking light source towards the user's eye, and wherein each of the second transparent delivery waveguides comprises a second curved portion between the second transparent feeder waveguide and the second output optical element.

Each transparent delivery waveguide may be additionally or alternatively adjacent to a layer of a same material as the transparent delivery waveguide, wherein the layer extends across an area of the transparent cover substrate, and the transparent delivery waveguide is at least partially defined by a space separating the transparent delivery waveguide from the layer. The transparent cover substrate may be additionally or alternatively located between the display substrate and the user's eye.

Another aspect provides a head-mounted display (HMD) device comprising: a frame; a transparent cover substrate supported by the frame; a display substrate supported by the frame; two or more eye-tracking light sources affixed to the frame; two or more input optical elements configured to receive eye-tracking light emitted by the two or more eye-tracking light sources; two or more transparent feeder waveguides, each of the two or more transparent feeder waveguides configured to receive at least a portion of the eye-tracking light via one of the input optical elements; wherein each of the two or more transparent feeder waveguides branches into a plurality of transparent delivery waveguides, each of the transparent delivery waveguides comprising an output optical element configured to output at least the portion of the eye-tracking light from the transparent delivery waveguide towards a user's eye, wherein each of the transparent delivery waveguides comprises a curved portion; and a camera configured to detect the eye-tracking light reflected by the user's eye.

The at least one transparent delivery waveguide of the plurality of transparent delivery waveguides may additionally or alternatively include a polymer material. At least one transparent delivery waveguide of the plurality of transparent delivery waveguides may be additionally or alternatively embedded in the transparent cover substrate. At least one transparent delivery waveguide of the plurality of transparent delivery waveguides may be additionally or alternatively affixed to an exterior surface of the transparent cover substrate. Each transparent feeder waveguide of the two or more transparent feeder waveguides may additionally or alternatively include an input optical element.

Each transparent delivery waveguide may be additionally or alternatively adjacent to a layer of a same material as the transparent delivery waveguide, wherein the layer extends across an area of the transparent cover substrate, and the transparent delivery waveguide is at least partially defined by a space separating the transparent delivery waveguide from the layer. The transparent cover substrate may be additionally or alternatively located between the display substrate and the user's eye.

Another aspect provides, at a head-mounted display (HMD) device comprising a frame, a transparent cover substrate supported by the frame, a display substrate supported by the frame, and a plurality of transparent delivery waveguides integrated with the transparent cover substrate, a method for detecting light reflected by a user's eye, the method comprising: emitting eye-tracking light from an eye-tracking light source affixed to the frame of the HMD device; providing the eye-tracking light to at least one input optical element for the plurality of transparent delivery waveguides; for each of the transparent delivery waveguides, directing the eye-tracking light along a path that includes a curved portion between the at least one input optical element and an output optical element, and outputting, via the output optical element, the eye-tracking light from the transparent delivery waveguide towards the user's eye; and detecting, at a camera, the eye-tracking light reflected by the user's eye.

Directing the eye-tracking light along the path may additionally or alternatively include directing the eye-tracking light along an embedded path that is embedded in the transparent cover substrate. Directing the eye-tracking light along the path may additionally or alternatively include directing the eye-tracking light along an exterior path located at an exterior surface of the transparent cover substrate. The method may additionally or alternatively include providing the eye-tracking light to a transparent feeder waveguide that branches into the plurality of transparent delivery waveguides.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A head-mounted display (HMD) device comprising:
a frame;
a transparent cover substrate supported by the frame;
a display substrate supported by the frame;
an eye-tracking light source affixed to the frame, the eye-tracking light source configured to emit eye-tracking light;
at least one input optical element configured to receive the eye-tracking light emitted by the eye-tracking light source;
a plurality of transparent delivery waveguides integrated with the transparent cover substrate and configured to receive the eye-tracking light via the at least one input optical element,
each of the transparent delivery waveguides comprising an output optical element configured to output the eye-tracking light from the transparent delivery waveguide towards a user's eye,
wherein each of the transparent delivery waveguides comprises a curved portion between the at least one input optical element and the output optical element; and
a camera configured to detect the eye-tracking light reflected by the user's eye.

2. The HMD device of claim 1, wherein at least one transparent delivery waveguide of the plurality of transparent delivery waveguides comprises a polymer material.

3. The HMD device of claim 1, wherein at least one transparent delivery waveguide of the plurality of transparent delivery waveguides is embedded in the transparent cover substrate.

4. The HMD device of claim 1, wherein at least one transparent delivery waveguide of the plurality of transparent delivery waveguides is affixed to an exterior surface of the transparent cover substrate.

5. The HMD device of claim 1, further comprising a transparent feeder waveguide configured to receive the eye-tracking light from the at least one input optical element, wherein the transparent feeder waveguide branches into the plurality of transparent delivery waveguides.

6. The HMD device of claim 1, wherein each transparent delivery waveguide of the plurality of transparent delivery waveguides comprises an input optical element.

7. The HMD device of claim 1, wherein the eye-tracking light source comprises a first eye-tracking light source, the at least one input optical element comprises a first input optical element, the plurality of transparent delivery waveguides comprises a plurality of first transparent delivery waveguides, the output optical element comprises a first output optical element, and each of the first transparent delivery waveguides comprises a first curved portion between the first input optical element and the first output optical element, the HMD device further comprising:
a first transparent feeder waveguide configured to receive the eye-tracking light emitted by the first eye-tracking light source from the first input optical element, wherein the first transparent feeder waveguide branches into the plurality of first transparent delivery waveguides;
a second eye-tracking light source affixed to the frame;
a second input optical element configured to receive eye-tracking light emitted by the second eye-tracking light source; and
a second transparent feeder waveguide configured to receive the eye-tracking light emitted by the second eye-tracking light source from the second input optical element, wherein the second transparent feeder waveguide branches into a plurality of second transparent delivery waveguides integrated with the transparent cover substrate and configured to receive the eye-tracking light emitted by the second eye-tracking light source via the second input optical element and the second transparent feeder waveguide,
each of the second transparent delivery waveguides comprising a second output optical element configured to output the eye-tracking light emitted by the second eye-tracking light source towards the user's eye, and
wherein each of the second transparent delivery waveguides comprises a second curved portion between the second transparent feeder waveguide and the second output optical element.

8. The HMD device of claim 1, wherein each transparent delivery waveguide is adjacent to a layer of a same material as the transparent delivery waveguide, wherein the layer extends across an area of the transparent cover substrate, and the transparent delivery waveguide is at least partially defined by a space separating the transparent delivery waveguide from the layer.

9. The HMD device of claim 1, wherein the transparent cover substrate is located between the display substrate and the user's eye.

10. A head-mounted display (HMD) device comprising:
a frame;
a transparent cover substrate supported by the frame;
a display substrate supported by the frame;
two or more eye-tracking light sources affixed to the frame;
two or more input optical elements configured to receive eye-tracking light emitted by the two or more eye-tracking light sources;
two or more transparent feeder waveguides, each of the two or more transparent feeder waveguides configured to receive at least a portion of the eye-tracking light via one of the input optical elements;
wherein each of the two or more transparent feeder waveguides branches into a plurality of transparent delivery waveguides, each of the transparent delivery waveguides comprising an output optical element configured to output at least the portion of the eye-tracking light from the transparent delivery waveguide towards a user's eye, wherein each of the transparent delivery waveguides comprises a curved portion; and
a camera configured to detect the eye-tracking light reflected by the user's eye.

11. The HMD device of claim 10, wherein at least one transparent delivery waveguide of the plurality of transparent delivery waveguides comprises a polymer material.

12. The HMD device of claim 10, wherein at least one transparent delivery waveguide of the plurality of transparent delivery waveguides is embedded in the transparent cover substrate.

13. The HMD device of claim 10, wherein at least one transparent delivery waveguide of the plurality of transparent delivery waveguides is affixed to an exterior surface of the transparent cover substrate.

14. The HMD device of claim 10, wherein each transparent feeder waveguide of the two or more transparent feeder waveguides comprises an input optical element.

15. The HMD device of claim 10, wherein each transparent delivery waveguide is adjacent to a layer of a same material as the transparent delivery waveguide, wherein the layer extends across an area of the transparent cover substrate, and the transparent delivery waveguide is at least partially defined by a space separating the transparent delivery waveguide from the layer.

16. The HMD device of claim 10, wherein the transparent cover substrate is located between the display substrate and the user's eye.

17. At a head-mounted display (HMD) device comprising a frame, a transparent cover substrate supported by the frame, a display substrate supported by the frame, and a plurality of transparent delivery waveguides integrated with the transparent cover substrate, a method for detecting light reflected by a user's eye, the method comprising:
emitting eye-tracking light from an eye-tracking light source affixed to the frame of the HMD device;
providing the eye-tracking light to at least one input optical element for the plurality of transparent delivery waveguides;
for each of the transparent delivery waveguides,
directing the eye-tracking light along a path that includes a curved portion between the at least one input optical element and an output optical element, and
outputting, via the output optical element, the eye-tracking light from the transparent delivery waveguide towards the user's eye; and
detecting, at a camera, the eye-tracking light reflected by the user's eye.

18. The method of claim 17, wherein directing the eye-tracking light along the path comprises directing the eye-tracking light along an embedded path that is embedded in the transparent cover substrate.

19. The method of claim 17, wherein directing the eye-tracking light along the path comprises directing the eye-tracking light along an exterior path located at an exterior surface of the transparent cover substrate.

20. The method of claim 17, further comprising providing the eye-tracking light to a transparent feeder waveguide that branches into the plurality of transparent delivery waveguides.
